(19) United States
(12) Patent Application Publication
(10) Pub. No.: US 2004/0256206 A1
(43) Pub. Date: Dec. 23, 2004

(54) Electrical disconnect locking device

(76) Inventor: Robert W. Jenkins, Brandon, MS (US)

Correspondence Address: ROBERT W. JENKINS, 103 BROOK ROAD, BRANDON, MS, 39047, US

(21) Appl. No.: 10/865,453

(22) Filed: Jun. 10, 2004

Related U.S. Application Data
(60) Provisional application No. 60/478,867, filed on Jun. 16, 2003.

(51) Int. Cl. H01H 31/00

(52) U.S. Cl. 200/48 R

(57) ABSTRACT

An in-line method and apparatus for making or breaking an electrical connection between a load circuit and a power source and locking same. This apparatus comprises a tamper proof housing with rotating plates that can be manually or electronically activated so as to connect or disconnect electrical current. When the rotating plates are locked in the contact position, the current flows freely. When the plates are rotated 90 degrees, the current is interrupted and locked.

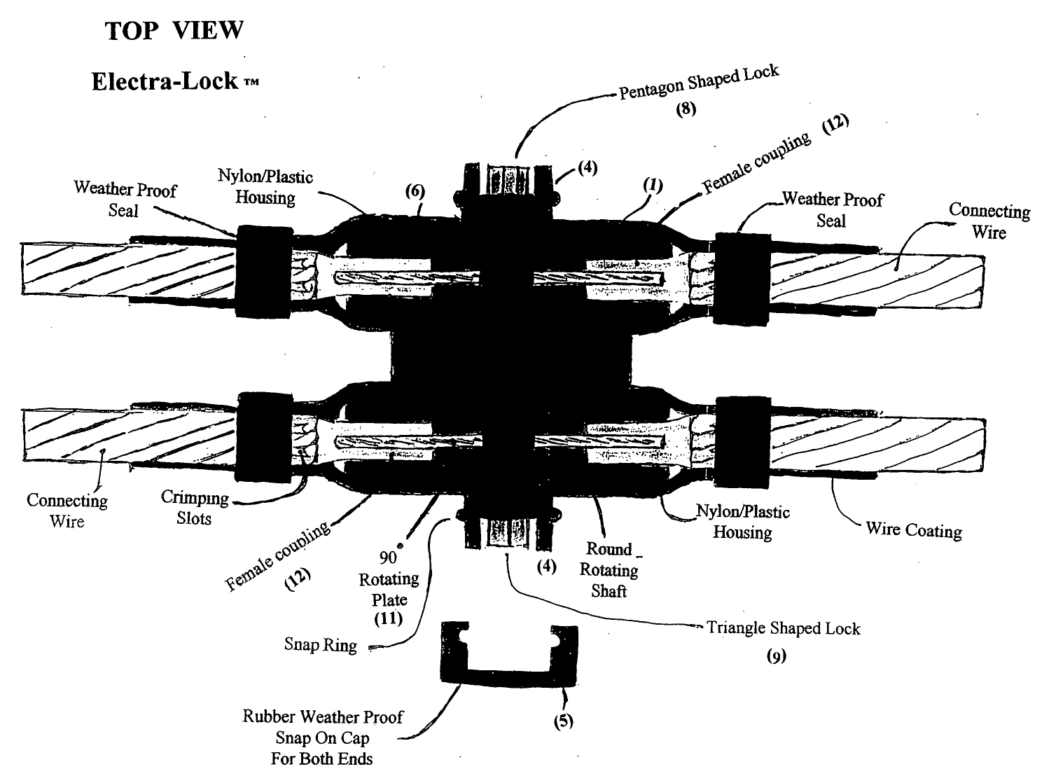

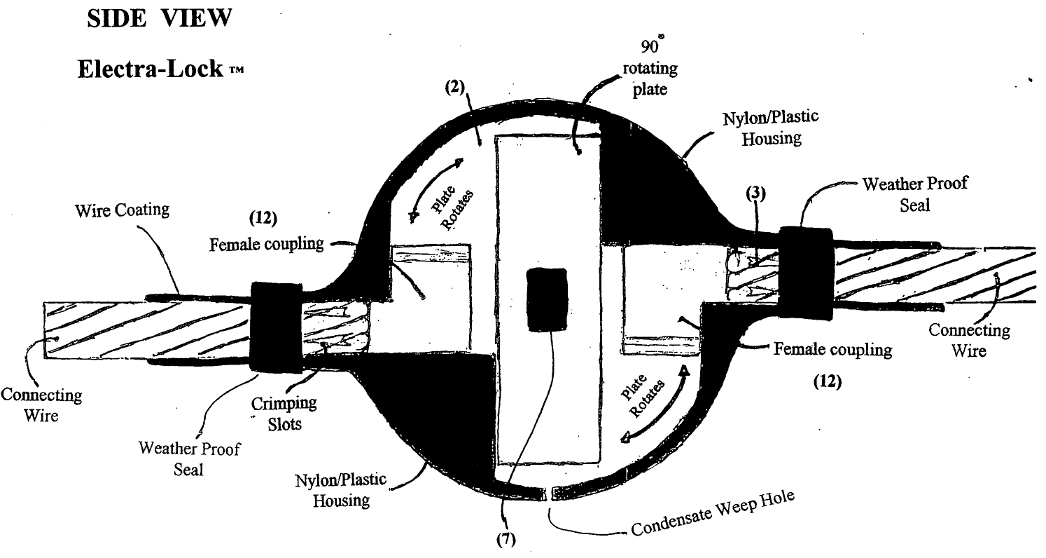

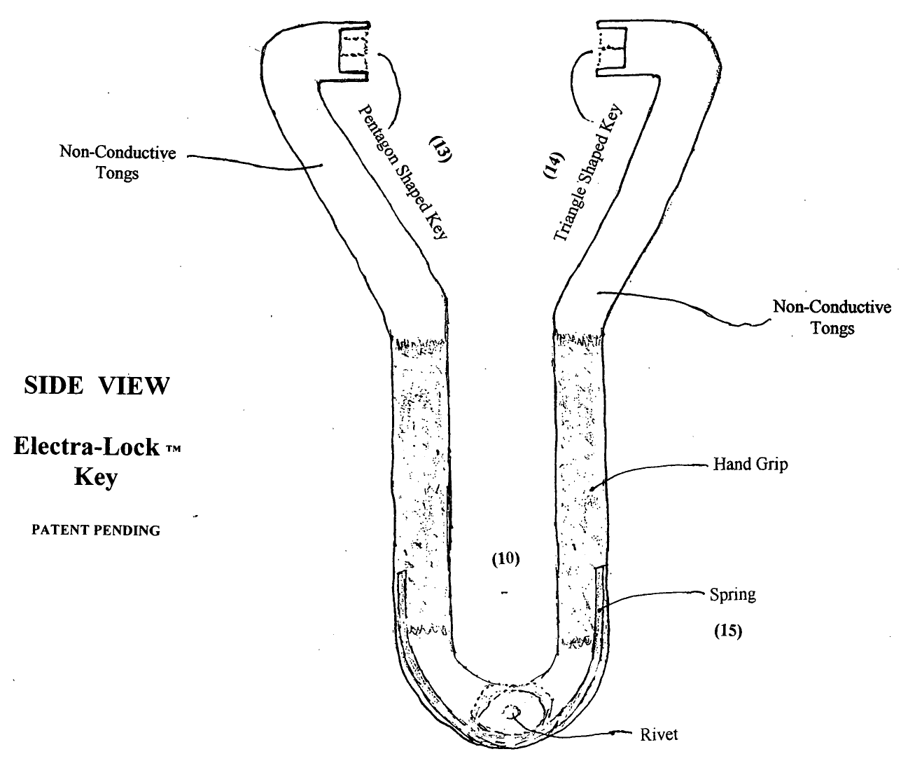

### RELATED APPLICATIONS

This application claims priority from U.S. Provisional Application 60/478,867, filed Jun. 6, 2003

### FIELD OF THE INVENTION

My present invention relates to an inexpensive apparatus that is placed in-line between the house weather head and the power pole to connect or disconnect the flow of electrical current via manual or remote means and self lock.

### BACKGROUND OF THE INVENTION

Presently, the utility companies are experiencing tremendous losses of electricity and electrical meters in blighted areas. The utility companies have tried numerous locking devices to try to prevent delinquent customers from opening meter bases and HOT WIRING the electricity. The major problem is that this act leaves the meter bases wide open and HOT. Any person could reach up and touch the HOT meter base and be electrocuted. Unfortunately, none of the locking devices are 100% effective. They are aimed at trying to lock the meter base. My invention will allow for the connection and the disconnection of the power AT THE WEATHER HEAD of the problem house. My apparatus will render the meter base COLD and discourage the delinquent customer from tearing up the meter base or stealing the meter.

### SUMMARY OF INVENTION

My invention will save lives by interrupting the electrical current to the meter base at the weather head. Thus, the meter base on the problem houses will be COLD. By having my apparatus installed in-line at the weather head (in clear view to all) this will discourage delinquents from stealing meters and destroying meter bases. It will also save the utility companies money via electricity and meter losses which in turn will help lower utility rates

What is claimed is:

1. An apparatus comprising at least two molded weather proof non-conductive housings bound together (1); each molded housing shall contain specifically designed concave caverns to allow for the rotating shaft and plates to rotate 90 degrees and stop (2). The molded housings shall further allow for the insertion of different size wires and different size weather proof seals (3). For the manual operation, the molded housing shall contain at least two openings (with snap rings) for the insertion of a specifically designed key to lock and unlock the electrical current (4). For the electronic operation, the molded housing shall be adaptable to such components. The rubber weather proof snap on caps shall mate to the snap rings (5).

2. The Round Rotating Shaft shall be made of strong non-conductive material specifically designed to rotate at least two conductive plates 90 degrees (6). The shaft at the rotating plate connection shall have square or rectangle or other shaped connections to secure the plates to the shaft (7). The rotating shaft ends could contain a specifically configured Pentagon shape on one end (8) and a Triangle shape on the other end (9) to allow for a matching key (10) to mate with the ends for locking and unlocking the apparatus.

3. The Rotating Plates (11) shall be made of conductive material and specifically designed to rotate at least 90 degrees to mate with a female connection to allow electrical current flow and to rotate 90 degrees in the opposite direction to disconnect the flow of electrical current and lock the apparatus.

4. The Female Coupling (12) is specifically designed to crimp or connect by other methods to different size wires on one end and specifically designed to mate with the rotating plates on the other end.

5. The Manual Key (10) shall be made of strong non-conductive material. One key end shall be female mated to the Pentagon shape rotating shaft end (13) and the other key end shall be female mated to the Triangle shaped rotating shaft end (14). Further the manual key shall comprise of at least two component parts with a spring loaded (15) connection.
